(19) United States
(12) Patent Application Publication
(10) Pub. No.: US 2026/0154728 A1
(43) Pub. Date: Jun. 4, 2026

(54) ELECTRONIC SHELF LABEL BEACON

(71) Applicant: TOSHIBA GLOBAL COMMERCE SOLUTIONS, INC., Durham, NC (US)

(72) Inventors: Daniel P. KELAHER, Fuquay-Varina, NC (US); Theodore R. CLARK, Allendale, NJ (US); Amy L. GRAY, Holly Springs, NC (US)

(21) Appl. No.: 18/968,794

(22) Filed: Dec. 4, 2024

(51) Int. Cl. G06Q 30/0601; G08B 3/10; G08B 5/22

(52) U.S. Cl. CPC G06Q 30/0639; G06F 17/00; G09F 3/208

(57) ABSTRACT

Embodiments herein describe using electronic shelf labels (ESLs) to help a customer find a particular item in a store. For example, a customer can load a retailer's application onto their mobile device and indicate to the application which items she would like to purchase. The retailer's application can instruct the ESL to perform a visual action to attract the customer's attention. This can include flashing a light on the ESL, or causing a portion of the display to change from off (white) to on (black). Once the ESL is identified, the customer can establish communication between the mobile device and the ESL so that the ESL can transmit display information that can be customized to the mobile device. The mobile device can then display the same (or similar) information as being displayed by the ESL, which can be used, e.g., for a visually impaired person.

### BACKGROUND

An electronic shelf label (ESL) is used by retailers for displaying, typically on the front edge of retail shelving, product pricing on shelves that can be updated or changed under the control of a central computer server. ESLs typically contain displays that use electronic paper (e-paper) or liquid-crystal displays (LCDs) to show the current product price to the customer. E-paper (or electronic ink (e-ink)) is often used on ESLs as it provides a crisp display and supports full graphic images (typically only black and white, but could include color) while only needing power during updates, and no power to retain an image. A communication network from the central computer server allows the price display to be automatically updated whenever a product price is changed, in contrast to static paper placards.

### BRIEF DESCRIPTION OF THE DRAWINGS

FIG. 1 illustrates an item location system that uses ESLs, according to embodiments herein.

FIG. 2 illustrates an item location system that uses ESLs, according to embodiments herein.

FIG. 3 is a flowchart for identifying items using an ESL, according to embodiments herein.

FIG. 4 illustrates attracting a customer's attention using an e-ink ESL, according to embodiments herein.

FIG. 5 illustrates displaying information on an ESL on a customer's mobile device, according to embodiments herein.

### DETAILED DESCRIPTION

Embodiments herein describe using ESLs to help a customer to find a particular product. For example, a customer can load a retailer's application onto their mobile device (e.g., a smartphone or tablet) and indicate to the application which item she would like to purchase. The retailer's application can then inform an ESL store controller which causes the ESL corresponding to the item to behave differently in order to attract the customer's attention. This can include activating a light on the ESL (e.g., an LED), flashing a light, causing a portion of the display to change from off (white) to on (black), and the like.

Once the ESL is identified, the customer can move her mobile device near the ESL, which can support near-field communication (NFC). The ESL can use a NFC connection with the mobile device to pass its display information to the mobile device, which in turns display the information of the mobile device (e.g., the same information being displayed on the ESL).

### Advantages of an ESL Item Location System

One non-limiting advantage of the embodiments herein is that using an ESL to attract a customer's attention can help visually impaired customers, or customers who cannot read the language used on the ESLs, to identify the items they wish to purchase. The customers can use the retailer's application (which may have a large enough font (or color contrast) to be readable to a visually impaired person, audibly output the information displayed on the ESL using a speaker, or use a language the customer can read) to indicate what items they wish to purchase. These customers can then use the visual indicators on the ESLs to identify the items.

In addition, after finding the items, the customer can use NFC so that the mobile device displays the information displayed on the ESL. The mobile device can have a much larger screen than the ESL, making it easier for a visually impaired customer to view the information. Also, the mobile device could perform a translation so that a customer who does not read the language can view the information displayed on the ESL in a language they can read. Thus, the embodiments herein can overcome the technical limitations of ESLs (e.g., having small screens or displaying information in only one language) by leveraging a customer's mobile device.

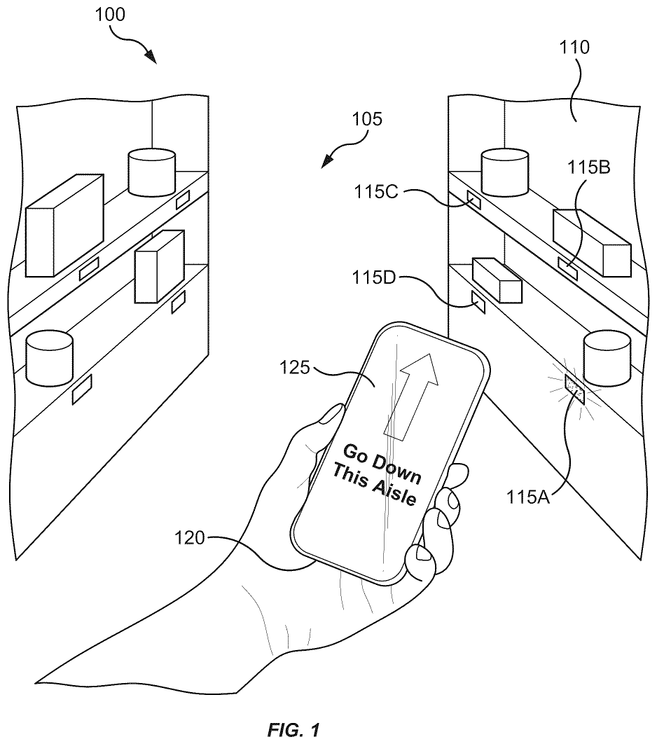

FIG. 1 illustrates an item location system 100 that uses ESLs 115, according to embodiments herein. In this example, a customer can use a mobile device 120 (e.g., a smartphone or tablet) to find a specific item on shelving 110 in an aisle 105 of a retail store. The retailer can place the ESLs 115 on the shelving 110 underneath (or above) items for sale. The ESLs 115 can display information about the corresponding items such as price, a price per unit, name and brand of the item, if the item is on sale, a bar code, etc.

In one embodiment, the mobile device 120 can have a store application installed which permits the customer to input a particular item she is looking for. The store application can then use the display 125 of the mobile device 120 to guide the user to the aisle 105 containing the item. For example, the store application could use global positioning system (GPS), a Wi-Fi or Bluetooth location technique, and the like to identify the customer's current location in the store (via the mobile device 120) and provide directions that lead the customer holding the mobile device 120 to the appropriate aisle 105.

However, the directions may not be granular enough to identify a particular item, especially when there can be multiple shelves in the shelving 110. Also, the customer may be visually impaired or may not read the language displayed in the ESLs. As such, the customer may not be able to read the ESL 115 to determine whether she is purchasing the correct product (or to evaluate the information displayed on the ESL to determine if she wants to purchase a different product).

In the embodiments herein, the item location system 100 can instruct the ESL corresponding to the item the customer is looking for (i.e., ESL 115A in FIG. 1) to perform a visual action that attracts the customer's attention. This can include turning on a light (e.g., a colored light emitting diode (LED), flashing a light, causing a portion of the display to switch been black and white, and the like. The ESL 115A can perform any function that visually distinguishes it from neighboring ESLs so that it catches the attention of the customer.

Since this attention-catching behavior can be seen by someone who is visually impaired or speaks a different language, a visually impaired customer or a customer who speaks a different language can easily identify the ESL 115A from the other neighboring ESLs 115B-D. As will be discussed in more detail below, once the ESL 115A is identified, the customer can bring the mobile device 120 close to the ESL 115 so that wireless communication is established between the ESL 115A and the mobile device 120. The ESL 115A can transfer the information it is displaying to the mobile device 120 so it can display the same information on its display 125.

If the customer is visually impaired, the information of the ESL 115A can be displayed with a different color contrast or in a much larger font on the display 125 than would be possible on the ESL 115A. The customer would then be able to read the information on the ESL 115A on their mobile device 120 and perform actions such as deciding whether they want to purchase the item, perform a price comparison (e.g., between a generic and a name brand item), identify the price per unit, see if the item is on sale, and the like.

If the customer does not read the language used by the ESL 115A, the store application can perform a translation of the information received from the ESL 115A and then display the translated information on the display 125. That way, the customer can ensure she is purchasing the correct item, perform a price comparison, see if the item is on sale, etc. For example, because the customer has moved the mobile device 120 to the ESL 115A, and receives the information from the ESL 115A, the customer can ensure she is purchasing the correct item once the translated information is output by the display 125.

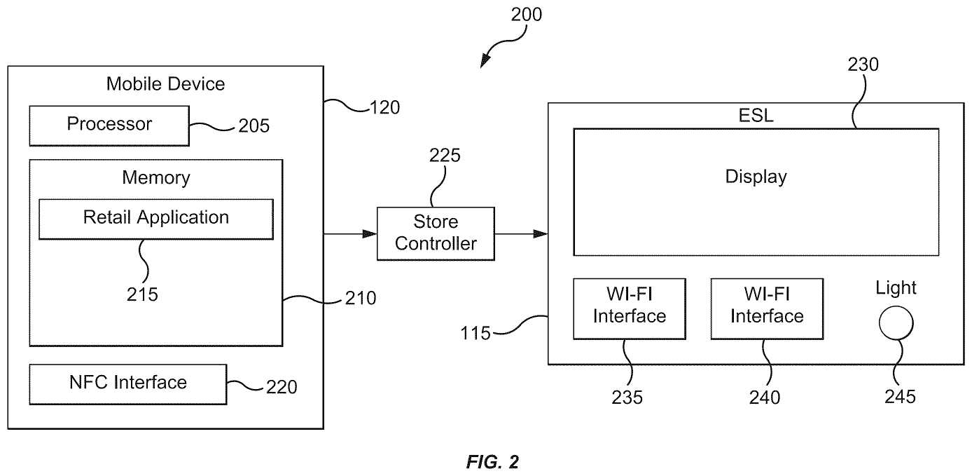

FIG. 2 illustrates an item location system 200 that uses ESLs, according to embodiments herein. The system 200 includes the mobile device 120, a store controller 225, and the ESL 115. In one embodiment, the mobile device 120 is a customer's mobile device such as smartphone or tablet. However in, another embodiment, the mobile device 120 may be a device provided by the retailer to its customers as they enter the store. As such, the embodiments herein are not limited to any particular mobile device.

The mobile device 120 includes a computer processor 205 which represents any number of processing elements (e.g., any number of central processing units (CPUs)) with any number of processing cores. The memory 210 can include volatile memory (e.g., random access memory (RAM)), nonvolatile memory, and combinations thereof. In this example, the memory 210 stores a retail application 215 (e.g., a retailer's software application) which the customer can use to access services such as the ones described herein - e.g., identifying a particular item (or a list of items) using ESLs 115. However, the retail application 215 can perform other functions such as scan-and-go item purchases, identifying items on sale, receiving and redeeming coupons, logging into a customer loyalty program, and the like.

The mobile device 120 also includes a NFC interface 220. NFC is a set of communication protocols that enables wireless communication between two electronic devices over a distance of approximately 4 cm. NFC communicating in one or both directions uses a frequency of 13.56 MHz in the globally available unlicensed radio frequency ISM band.

While the embodiments herein discuss using NFC to communicate between the mobile device 120 and the ESL 115, this is just one example of a suitable communication protocol. Other proximity based communication protocols could be used such as RFID, or using QR codes (where the ESL 115 displays a QR code which is read using a camera on the mobile device 120).

The ESL 115 includes a display 230, Wi-Fi interface 235, NFC interface 240, and a light 245. The display 230 may be an electronic ink (e-ink) display which saves power relative to other types of display screens. If the ESL 115 operates under battery power, the display 230 may be an e-ink display. But in other embodiments, the display 230 may be other types of displays such as LED or LCD, and may be coupled to a power source rather than being battery operated. In other embodiments, the display 230 may be a touch screen so that a user can interact with it, such as selecting a virtual button.

The Wi-Fi interface 235 can include a transmitter/receiver (transceiver) for transmitting and receiving Wi-Fi data. For example, the Wi-Fi interface 235 can connect to a Wi-Fi network in the store. The Wi-Fi interface 235 can be used by the store employer to remotely change what is displayed on the display 230 using the store controller 225. For example, the price of the product can be updated if the corresponding product is put on sale.

The NFC interface 240 permits the ESL 115 to use NFC to communicate with store employees'devices as well as the customer's user device (e.g., the mobile device 120). A store employee can use the NFC interface 240 to update the display 230, or the customer's user device may use the NFC interface 240 to receive the information currently displayed on the ESL 115, as discussed in more detail below.

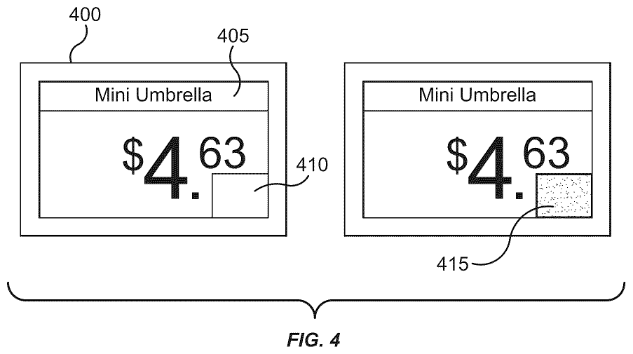

The light 245 can be any light (e.g., a LED) that can be activated. In one embodiment, the light 245 is used to attract the customer's attention. For example, if a customer has indicated to the store controller 225 that she wishes to purchase the item corresponding to the ESL 115, the store controller 225 can cause the light 245 to flash or otherwise illuminate. However, in other embodiments, a portion of the display 230 may flash to attract the customer's attention, which will be discussed in FIG. 4.

FIG. 2 is just one example of the ESL 115 and its features. For example, other ESL implementations may not include all the features shown. One ESL may include the Wi-Fi interface 235, but not the light 245. Another ESL may include the NFC interface 240 but not the Wi-Fi interface 235 or the light 245.

The store controller 225 can be a software application executing on a computing system (e.g., a server). The store controller 225 can also be a specialized hardware device.

In one embodiment, the store controller 225 updates the ESLs 115. The system 200 can include a communication network (e.g., a Wi-Fi network) that permits the store controller 225 to change the information displayed on the ESLs 115 (e.g., update price information when there is a sale, change the information when a different item is associated with ESL, and like).

The store controller 225 can also communicate with the retail application 215. For example, the retail application 215 can receive input from the customer indicating which item the customer wants to purchase. The store controller 225 can then identify the ESL 115 corresponding to that item and cause the ESL 115 to perform a visual action to distinguish the ESL 115 from neighboring ESLs and to catch the customer's attention (e.g., cause the light 245 to flash).

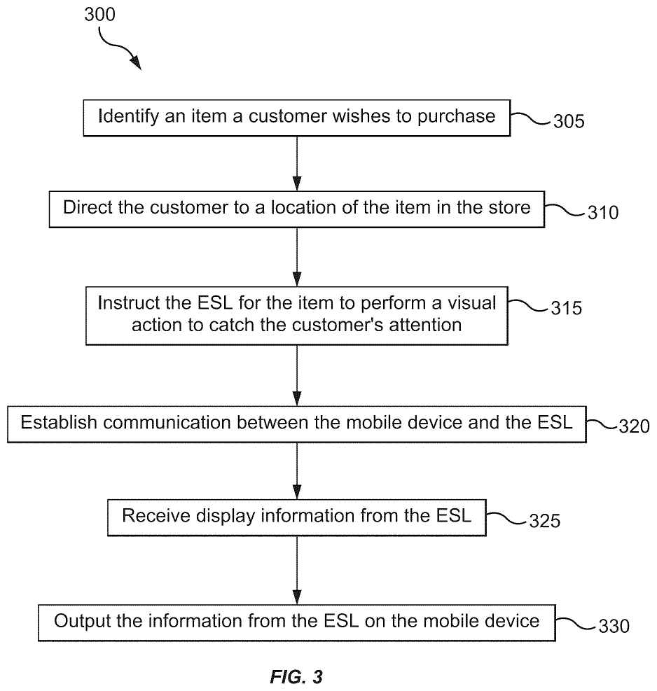

FIG. 3 is a flowchart of a method 300 for identifying items using an ESL, according to embodiments herein. At block 305, the retail application (e.g., the retail application 215 in FIG. 2) identifies an item a customer wishes to purchase. For example, the customer may type in the name of a product in a search feature in the application. Or the retail application may display on the mobile device a weekly advertisement where the customer can select (e.g., by touching) a displayed item she wishes to purchase.

In another embodiment, the customer may build a shopping list using the retail application, or can import a shopping list from another application (e.g., a shared note between family members).

At block 310, the retail application directs the customer to a location of the item in the store. For example, FIG. 1 illustrates a mobile device 120 that provides in-store directions (e.g., walking directions) to a particular aisle containing the identified item. The directions could be a directional arrow as shown, but could also be a walking path or some other guidance technique.

In one embodiment, if the location of the customer is not known, the retail application can provide an aisle number (or grid number) to the customer. The customer can then use signage in the store to then find the aisle containing the item the customer wishes to purchase.

At block 315, the retail application instructs the ESL for the item to perform a visual action to catch the customer's attention. To do so, in one embodiment the retail application informs a store controller (e.g., the store controller 225 in FIG. 2) of the item the customer wishes to purchase. The store controller can then identify the ESL in the store corresponding to that item and send an instruction to the ESL to perform a visual action that attracts the customer's attention. The neighboring ESLs may not perform this action so that the ESL sticks out, and thus, can easily be identified by the customer.

The visual actions could include illuminating a light on the ESL (e.g., the light 245 in FIG. 2), flashing the light, causing the display to change colors, and the like.

FIG. 4 illustrates attracting a customer's attention using an e-ink ESL 400, according to embodiments herein. The ESL 400 includes an e-ink display 405. The store controller can instruct the ESL 400 to switch between two different display states in order to attract the customer's attention who is looking for the corresponding item.

In the first state, a box 410 is displayed that includes a black border that surrounds white pixels. In the second state, a box 415 is displayed that includes a solid black box of black pixels (represented by speckles/shading in FIG. 4) with the same dimensions as the box 410. The rest of the display 405 may be the same in the two states.

The ESL 400 can switch between the two states (e.g., every half a second or so) so that the boxes 410, 415 cause the display 405 to have a flashing effect. That is, the portion of the display 405 with the boxes 410, 415 appears to flash while the other displayed information does not change. This will cause the ESL 400 to stick out relative to other neighboring ESLs that do not have changing displays. As such, FIG. 4 illustrates one example of a visual action that can be performed at block 315 of method 300.

Flashing the display 405 as shown in FIG. 4 may be preferred for ESLs that do not have lights, or are powered by battery as it may use less power than illuminating a light.

Returning to the method 300, at block 320 the mobile device establishes communication with the ESL. For example, after a customer identifies the ESL performing the visual action, the customer can move the mobile device to establish short-range communication between the mobile device and the ESL. In one embodiment, this communication is provided using NFC interfaces on the mobile device and the ESL. In another embodiment, this communication is provided using RFID. In yet another embodiment, this communication can include the mobile device capturing an image of a QR code displayed on the ESL.

At block 325, the mobile device receives display information from the ESL. For example, the ESL can transfer data using a NFC connection to the mobile device where the data contains the information that is currently being displayed on the ESL (e.g., the name of the item, the price of the item, a unit price, etc.). In another embodiment, this data can be transferred using RFID to the mobile device.

In yet another embodiment, the display information can be encoded into a QR code which, when decoded by the mobile device, includes the information that is currently being displayed on the ESL. For example, as the store controller updates the ESLs, it can also update the QR codes so these codes encode the current information being displayed on the ESL.

At block 330, the mobile device outputs the information received from the ESL. For example, the mobile device may display a copy of what is being displayed on the ESL, but only as a bigger version (since the display of the mobile device may be much larger than the display of the ESL). This can enable a visually impaired person to view the same information being displayed on the ESL on her larger mobile device. In another embodiment, the mobile device uses a speaker to audibly output the information being displayed on the ESL.

In another embodiment, the mobile device may display a different version of the information being displayed on the ESL. For example, the retail application may perform a translation of the information and display the translated information on the display. In this example, the mobile device displays the same information as what is displayed in the ESL, but in a different language. For instance, the retail application may support several languages so that the customer can select the language she is most comfortable with. The customer can use that language when identifying the item she wishes to purchase at block 305 using the retail application. Moreover, the retail application can direct the customer to the location of the item at block 310 also using her preferred language (e.g., output directions in the customer's preferred language).

In another embodiment, the mobile device may display less information than what is displayed in the ESL. For example, the ESL may display a bar code, which is not displayed on the mobile device. This can save room in the display to make more important information (e.g., the name of the item and the price) larger in the display, which can be useful for a visually impaired person.

In another embodiment, the mobile device may display more information that what is displayed in the ESL. For example, the retail application may query the store controller to receive more information about the item which may not be on the ESL, such as an expiration date of the item, if a related item (e.g., a store brand version of the item) is on sale, and the like.

One advantage of using a NFC, RFID, or a QR code to retrieve and display the information on the ESL on the mobile device is doing so ensures the customer has found the correct item. For example, the mobile device could query the store controller to retrieve the information being displayed on the ESL, rather than retrieving this information from the ESL itself. However, the customer may be looking at the wrong ESL, and thus, may purchase the wrong item, especially since items can look similar (e.g., different types of ibuprofen, or a gallon of 1% milk versus a gallon of 2% milk). By establishing communication between the mobile device and the ESL, the customer can view the displayed information on the mobile device (which can include the name and brand of the item) and ensure she has found the correct ESL.

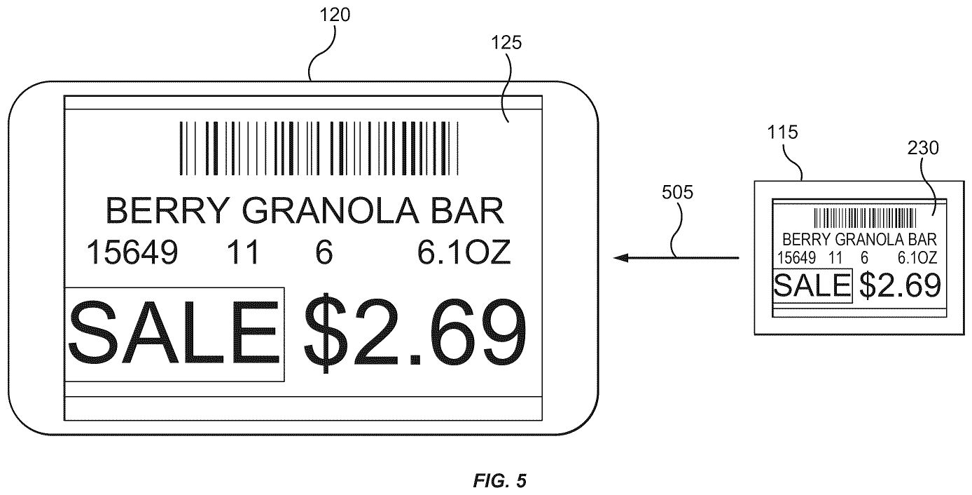

FIG. 5 illustrates displaying information on an ESL 115 on a customer's mobile device 120, according to embodiments herein. FIG. 5 illustrates an ESL 115 with a display 230 displaying information about an item such as its price, the fact it is on sale, the name of the item, the weight of the item, a bar code, and so forth.

FIG. 5 illustrates transmitting the displayed information 505 (e.g., item name, price, sale status, weight, etc.) from the ESL 115 to the mobile device 120. The displayed information 505 can be transferred wireless using any of the techniques discussed at blocks 320 and 325 of method 300, such as NFC, RFID, a QR code, and the like.

The mobile device 120 receives the displayed information 505 and then displays the same information that is displayed on the ESL 115. That is, in this embodiment, the image displayed on the display 125 is the same as what is displayed on the display 230 except that the image may be larger (assuming it is full screen on the display 125). Put differently, the display 125 can display a copy of what is displayed on the ESL 115.

While the information displayed by the mobile device 120 and the ESL 115 may be the same, the size, color, contrast, etc. may be different due to using different display technologies in the mobile device 120 and the ESL 115.

Moreover, as discussed above, in other embodiments the information displayed by the mobile device 120 and the ESL 115 may be different. For example, the mobile device 120 may display a subset of the information displayed on the ESL 115. For instance, the bar code may be removed. Or the mobile device 120 may display other information that is not displayed on the ESL 115, such as prices of related items.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference was made to embodiments presented in this disclosure. However, the scope of the present disclosure is not limited to the described embodiments. Instead, any combination of the features and elements discussed above, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the aspects, features, embodiments and advantages discussed here are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the described embodiments, a user may access applications (e.g., the store application) or related data available in the cloud. For example, the store controller could execute on a computing system in the cloud and communicate with the customer's mobile device and the ESLs in a store. In such a case, the store controller could store the information displayed on the ESLs at a storage location in the cloud. Doing so allows a user to access this information from any computing system attached to a network connected to the cloud (e.g., the Internet).

While the foregoing is directed to one or more embodiments, other and further embodiments may be devised without departing from the basic scope thereof, and the scope thereof is determined by the claims that follow.

What is claimed is:

1. A method comprising:
identifying an item for purchase in a retail store;
instructing an electronic shelf label (ESL) corresponding to the item to perform a visual action;
establishing communication between a mobile device and the ESL;
receiving display information from the ESL; and
outputting the display information on the mobile device.

2. The method of claim 1, wherein establishing communication between the mobile device and the ESL further comprises:
outputting directions on the mobile device to lead a customer holding the mobile device to the item in the retail store.

3. The method of claim 1, wherein establishing communication between the mobile device and the ESL further comprises:
establishing near-field communication (NFC) using respective NFC interfaces in the mobile device and the ESL.

4. The method of claim 3, wherein the display information is transmitted from the ESL to the mobile device using NFC.

5. The method of claim 1, wherein the display information comprises information currently being displayed on the ESL regarding the item.

6. The method of claim 5, wherein the mobile device displays the same information being displayed on the ESL regarding the item, but the information is larger than when displayed on the ESL.

7. The method of claim 1, further comprising:
translating the display information received from the ESL into a different language, wherein the display information is displayed in the different language on the mobile device.

8. The method of claim 1, wherein the visual action comprises at least one of:
illuminating a light on the ESL; or
changing a portion of an electronic ink (e-ink) display of the ESL from white pixels to black pixels to cause a flashing effect.

9. The method of claim 1, wherein outputting the display information on the mobile device comprises audibly outputting the display information using a speaker on the mobile device.

10. A mobile device, comprising:
one or more memories; and
one or more processors communicatively coupled to the one or more memories, the one or more processors configured to, individually or collectively, perform operations comprising:
identifying an item for purchase in a retail store;
instructing an electronic shelf label (ESL) corresponding to the item to perform a visual action;
establishing communication between the mobile device and the ESL;
receiving display information from the ESL; and
outputting the display information on the mobile device.

11. The mobile device of claim 10, wherein establishing communication between the mobile device and the ESL further comprises:
outputting directions on the mobile device to lead a customer holding the mobile device to the item in the retail store.

12. The mobile device of claim 10, wherein establishing communication between the mobile device and the ESL further comprises:
establishing near-field communication (NFC) using respective NFC interfaces in the mobile device and the ESL.

13. The mobile device of claim 12, wherein the display information is transmitted from the ESL to the mobile device using NFC.

14. The mobile device of claim 10, wherein the display information comprises information currently being displayed on the ESL regarding the item.

15. The mobile device of claim 14, wherein the mobile device displays the same information being displayed on the ESL regarding the item, but the information is larger than when displayed on the ESL.

16. The mobile device of claim 10, wherein the operations further comprise:
translating the display information received from the ESL into a different language, wherein the display information is displayed in the different language on the mobile device.

17. The mobile device of claim 10, wherein outputting the display information on the mobile device comprises audibly outputting the display information using a speaker on the mobile device.

18. An ESL comprising:
a first wireless interface configured to receive an instruction to perform a visual action to catch the attention of a customer searching for an item corresponding to the ESL; and
a second wireless interface configured to:
establish communication with a mobile device, and
transmit information currently being display by the ESL to the mobile device, wherein the mobile device outputs the information to the customer.

19. The ESL of claim 18, wherein establishing communication between with the mobile device further comprises:
establishing near-field communication (NFC) using respective NFC interfaces in the mobile device and the ESL, wherein the display information is transmitted from the ESL to the mobile device using NFC.

20. The computer readable storage medium of claim 16, wherein the display information comprises information currently being displayed on the ESL regarding the item, wherein the mobile device displays the same information being displayed on the ESL regarding the item, but the information is larger than when displayed on the ESL.
